(19) United States
(12) Patent Application Publication
(10) Pub. No.: US 2008/0112358 A1
(43) Pub. Date: May 15, 2008

(54) Cell protocol adapting between single and concurrent interfering transmissions and receptions based on channel conditions

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvin, CA (US)

(21) Appl. No.: 11/641,197

(22) Filed: Dec. 18, 2006

Related U.S. Application Data
(63) Continuation-in-part of application No. 11/595,346, filed on Nov. 9, 2006.

(51) Int. Cl. H04Q 7/00

(52) U.S. Cl. 370/329

(57) ABSTRACT

A wireless network infrastructure that adapts between single and concurrent interfering transmissions and receptions based on dynamically varying channel conditions. The channel conditions variations are typically determined by the number of associated wireless end point devices within the cell, their capabilities, anticipated bandwidth usage, QOS (Quality Of Service) demands, priority of service, idle states, cell overlap interferences, near-far interferences, and noises. The wireless network infrastructure supports a plurality of end point devices and contains an access point. The access point defines at least one first portion of a frame wherein transmissions and receptions are limited to single transmissions and receptions, and at least one second portion of the frame wherein concurrent interfering transmissions and receptions are permitted. The access point responds to the dynamically varying channel conditions by adapting a frame between the first portion that allows single transmissions and the second portion that allows concurrent interfering transmissions.

### CROSS REFERENCES TO RELATED APPLICATIONS

The present application is a continuation-in-part of Utility Application Ser. No. 11/595,346 filed on Nov. 9, 2006, and entitled “ADAPTIVE NETWORK SUPPORTING SINGLE TO CONCURRENT INTERFERING WIRELESS TRANSMISSIONS,” (BP5761), which is incorporated herein in its entirety by reference for all purposes.

### BACKGROUND

1. Technical Field

The present invention relates generally to wireless communication; and, more particularly, to wireless access points in a packet switched network.

2. Related Art

Wireless access points provide mobile computing devices wireless access to backbone networks in both public and private places, within a wireless network infrastructure. The wireless network infrastructures include wireless local area networks that essentially contain wireless access points and a plurality of mobile end point wireless devices. One of the widespread usages of wireless access points is to link the plurality of mobile wireless end point devices to the Internet, wirelessly. Thus, today wireless access points provide wireless access to the Internet in may public places such as restaurants, air ports, and public buildings as well as at homes.

End point wireless devices include personal or laptop computers, servers, set top boxes and handheld data/communication devices, for example. Often a plurality of wireless access points is bridged to provide additional coverage area. The communication between wireless access points and the end point wireless devices occur on the basis of predefined sets of rules or protocols.

However, the channel conditions within a wireless network infrastructure that includes a wireless access point vary widely and dynamically based upon a plurality of factors. The plurality of factors includes number of associated wireless end point devices within the cell, bandwidth usage, QOS (Quality of Service), priority of service, interferences, and noises.

For example, in airports, number of users who access Internet may vary widely depending on the passengers waiting for their flights. Similarly, unexpected bandwidth or high quality of service demands from many of the users creates a bottleneck in the wireless network infrastructure, making it inconvenient for the other users. Other factors that create bottlenecks include cell overlap interferences, near-far interferences and noises, such as electromagnetic noise created by a microwave oven.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram illustrating a wireless network infrastructure built in accordance with various aspects of the present invention, wherein a wireless access point adapts frame between single and concurrent interfering transmissions and receptions based on varying channel conditions;

FIG. 2 is a flow diagram illustrating general flow of functionality of the wireless access point of FIG. 1;

FIG. 3A is a flow diagram illustrating flow of functionality of the wireless access point of FIG. 1, wherein the wireless access point adapts the frame in response to the varying channel conditions created by an incoming wireless end point device;

FIG. 3B is a flow diagram illustrating flow of functionality of the wireless access point of FIG. 1, wherein the wireless access point adapts the frame in response to the varying channel conditions created by an outgoing wireless end point device;

FIG. 4A is a flow diagram illustrating flow of functionality of the wireless access point of FIG. 1, wherein the wireless access point adapts the frame in response to the varying channel conditions created by varying bandwidth requirements, high priority services and idle states of a wireless end point device;

FIG. 4B is a flow diagram illustrating flow of functionality of the wireless access point of FIG. 1, wherein the wireless access point adapts the frame in response to the varying channel conditions created by varying quality of service of a wireless end point device;

FIG. 5A is a flow diagram illustrating flow of functionality of the wireless access point of FIG. 1, wherein the wireless access point adapts the frame in response to the varying channel conditions created by electromagnetic noises and interferences within the wireless network infrastructure;

FIG. 5B is a flow diagram illustrating flow of functionality of the wireless access point of FIG. 1, wherein the wireless access point utilizes additional radio channels in response to the varying channel conditions created by high bandwidth requirements of a wireless end point device and interferences within the wireless network infrastructure;

FIG. 6 is a timing diagram illustrating adaptation of frame between single and concurrent interfering transmissions and receptions based on channel conditions, wherein channel conditions demand low or high bandwidth;

FIG. 7 is a schematic block diagram of an alternate embodiment of the network infrastructure of FIG. 1 illustrating a wireless access point and variety of wireless end point devices, in accordance with various and other aspects of the present invention;

FIG. 8 is a schematic block diagram of a wireless access point built in accordance with the embodiment of FIG. 7; and

FIG. 9 is a schematic block diagram of a wireless end point device built in accordance with the embodiment of FIG. 7.

### DETAILED DESCRIPTION OF THE DRAWINGS

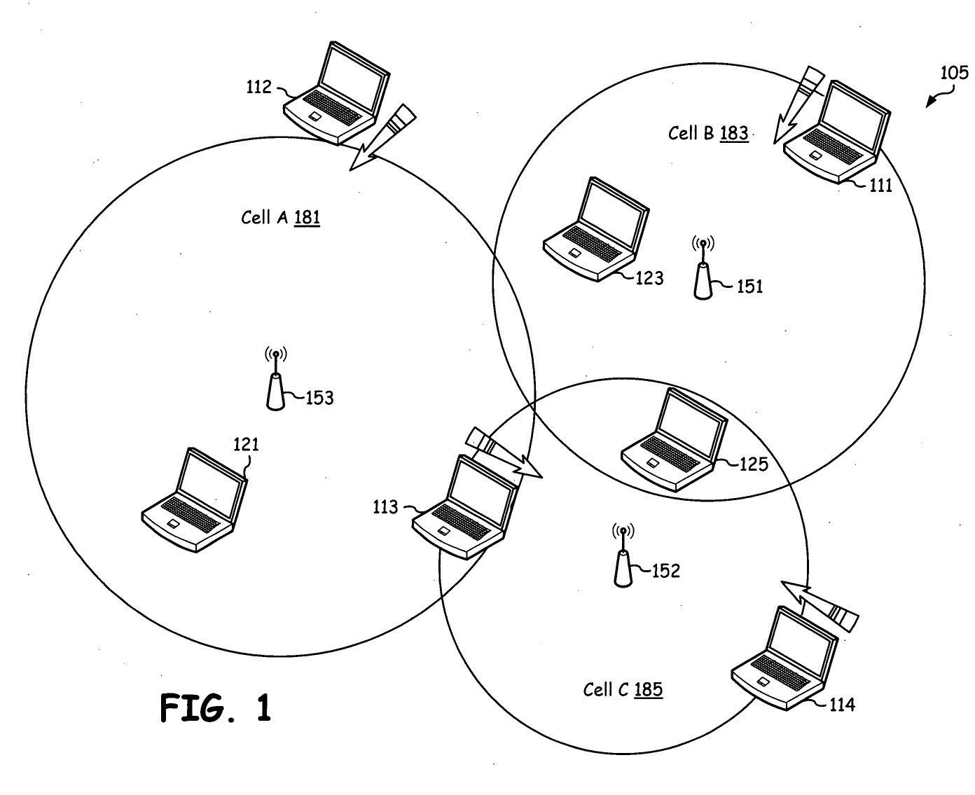

FIG. 1 is a schematic block diagram illustrating a wireless network infrastructure 105 built in accordance with various aspects of the present invention, wherein a wireless access point adapts frame between single and concurrent interfering transmissions and receptions based on varying channel conditions. The wireless network infrastructure 105 covers a large area, serviced by a plurality of wireless access points such as 151, 152, and 153. Each of the wireless access points 151, 152 or 153 service their respective cell areas, that is, cell B 183, cell C 185 or cell A 181. In some areas, the cells 183, 185 and 181 overlap. Wireless end point devices, that are serviced by the wireless access points 151, 152 and 153 are illustrated in FIG. as notebook or laptop computers 111 through 114, 121, 123 and 125, may in reality as well be handheld devices, desktop computers or any prospective end point devices that may be serviced by the wireless access points 151, 152 and 153. Some of the wireless end point devices 111 through 114, 121, 123 and 125 are single transmission capable devices (that is, supports only single transmissions and receptions), or concurrent interfering transmission capable devices (in other words, support only concurrent interfering transmissions and receptions), or both.

In specific, the wireless access points 151, 152 and 153 adapt a frame between single and concurrent interfering transmissions, by taking into consideration various factors that dynamically affect channel conditions and thus wireless access point's performance. These factors that affect channels conditions include load variations caused by incoming and outgoing wireless end point devices 111 through 114, interference caused by wireless end point devices in the overlapping regions 113 and 125, interference caused by near-far effects, varying bandwidth demands from wireless end point devices 111 through 114, 121, 123 and 125 and noises within the cell area. The cell protocol allows adaptation of a frame, in both contention free mode and contention mode, between single and concurrent interfering transmissions. The wireless access points 151, 152 and 153 allow single transmissions and receptions in a first portion of the frame and allow at least concurrent interfering transmissions in a second portion of the frame.

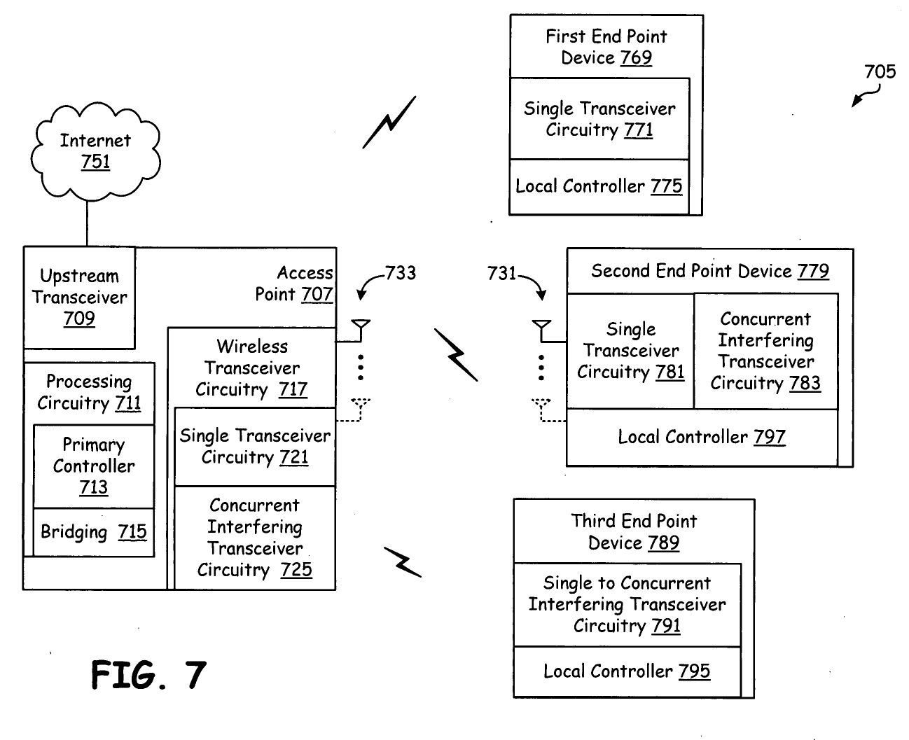

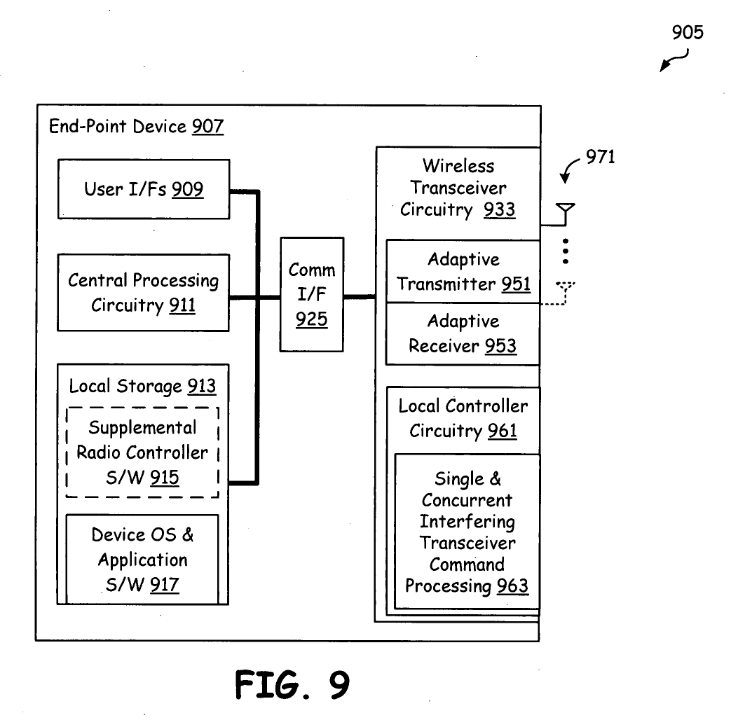

In accordance with the present invention, the wireless access points 151, 152, and 153 support both single transmission capable wireless end point devices and concurrent interfering transmission capable wireless end point devices. To support both the single transmission capable wireless end point devices and concurrent interfering transmission capable wireless end point devices, the wireless access points 151, 152, and 153 contain wireless downstream transceivers. These wireless downstream transceivers further contain single transmissions and receptions transceivers and concurrent interfering transmissions and receptions transceivers. A primary controller circuitry activates the single transmissions and receptions transceivers during the first portion of the frame and concurrent interfering transmissions and receptions transceivers during the second portion of the frame. The duration length for each of these are adjusted by considering factors that dynamically affect channel conditions and wireless access point's performance. In addition, the wireless access point contains a plurality of antennas that support transmissions and receptions in various radio bands, thus allowing the wireless access point to adapt to the channel conditions, by utilizing transmissions and receptions in various radio bands. The construction details of the wireless access points 151, 152 and 153 are described with reference to the FIGS. 7 and 9.

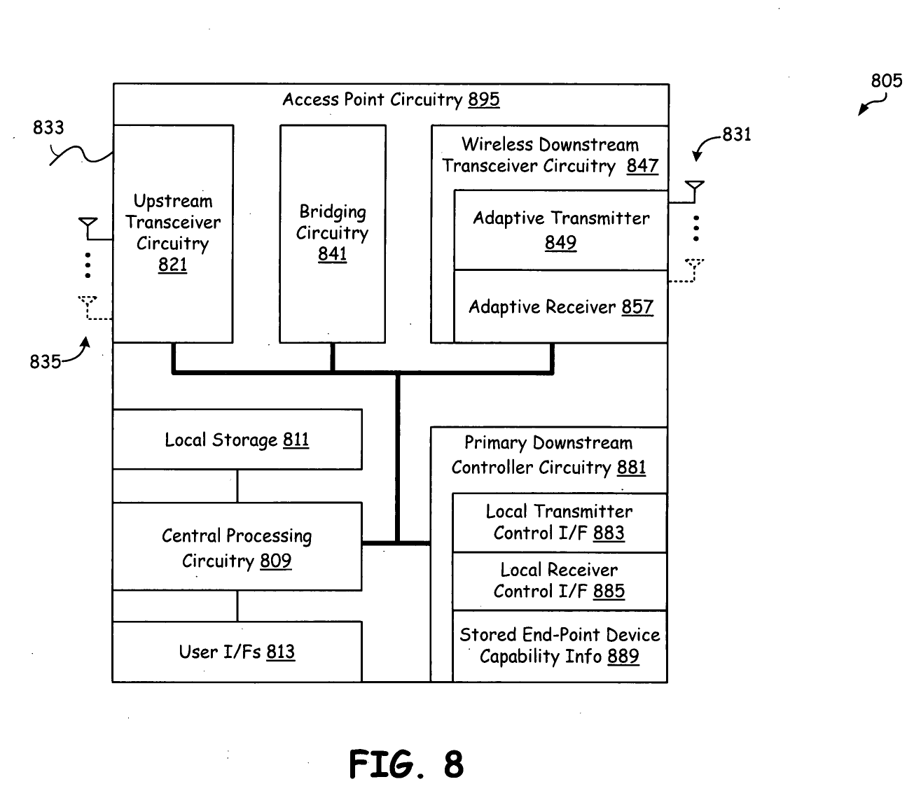

Similarly, the wireless end point devices that are both single and concurrent interfering transmission capable contain single transmissions and receptions transceivers and concurrent interfering transmissions and receptions transceivers. A controller circuitry activates the single transmissions and receptions transceivers during the first portion of the frame and concurrent interfering transmissions and receptions transceivers during the second portion of the frame, based upon control signals from the access point during beacon period and frame period. The construction details of the wireless end point devices 111 through 114, 121, 123, and 125 are described with reference to the FIGS. 7 and 8.

One of the ways in which a dynamically varying channel conditions is created is by way of various wireless end point devices, such as end point devices 111 through 114, come floating into the respective cells or leaving the cells. The incoming wireless end point devices such as 112 in case of cell A 181, create demand for additional bandwidth from the access point. If, in this case, the wireless end point device 112 is concurrent interfering transmission capable device, then the wireless access point 153 gains additional leverage to adjust the second portion of the frame such a way that this demand for additional bandwidth is offset and performance of the wireless access point 153 is not degraded. In addition, the wireless access point 153 may also utilize additional radio bands for transmissions and receptions. Thus, the overall users Internet access experience within the cell A, for example, is not affected in any way, even when many new users enter into the region of cell A. Similarly, outgoing wireless end point devices, such as 113 in case of cell A 181, reduce overall bandwidth demand on the wireless access point 153. In addition, the proportion of wireless end point devices that are only single transmission capable devices is also a factor in adaptation of the frame. In this situation, if proportion of only single transmission capable devices is high, then the wireless access point 153 adapts to such a channel condition by keeping the first portion of the frame large. This would ensure that the user experience of single transmission capable devices is not affected.

Another way in which a dynamically varying channel conditions is created is by way of bandwidth requirements of the wireless end point devices, such as when transferring files or when a VoIP communication is initiated. During these high priority services, the individual wireless end point devices demand higher bandwidth. Similarly, when some individual wireless end point devices demand higher Quality of Service (QOS), it creates a demand for higher bandwidth. The wireless access points 151, 152 and 153 adapt to these varying channel conditions by adjusting the frame between single transmissions and receptions (in the first portion of the frame) and concurrent interfering transmissions (in the second portion of the frame). In addition, the wireless access point 151, 152, and 153 may also utilize additional radio bands for transmissions and receptions.

A third factor that creates dynamically varying channel conditions is that of channel degradation due to interferences and noises. Interferences include interference due to overlaps between cells, such as illustrated between cell A 181, cell B 183,, and cell C 185 and near far interference caused by some of the wireless end point devices being closer to the wireless access points 151, 152, or 153 than others. In the later case, the interference is caused by uneven signal strengths between signals arriving from various wireless end point devices. The noises are unwanted radio frequencies generated by devices that may utilize the same radio band as the ones utilized by the access points 151, 152 and 153, or generated unintentionally by these devices. The wireless access points 151, 152 and 153 adapt to these varying channel conditions by adjusting the frame between single transmissions and receptions and concurrent interfering transmissions, and also by utilizing additional radio bands for transmissions and receptions, if required.

For example, a wireless access point installed at an airport may create dynamically varying channel conditions, when passengers carrying notebook computers or handheld devices come in during just before plane departure. Many of these users utilize the services of the wireless access point only for a short period, creating a temporary high bandwidth demand from the wireless access point. At least, some of these notebooks and handheld devices may have concurrent interfering transmission capabilities. The wireless access point learns about the capabilities of each of these notebooks and handheld devices, their bandwidth and idle state requirements, and optimizes its performance accordingly by adjusting the frame between single transmissions and concurrent interfering transmissions. The wireless access point also considers interferences and noises while optimizing the performance. The noise, for example, may come from machinery such as microwaves.

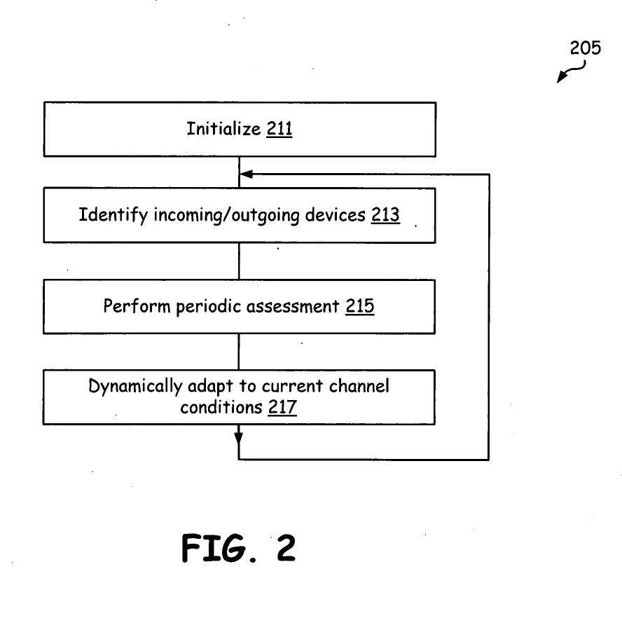

FIG. 2 is a flow diagram illustrating general flow of functionality 205 of the wireless access point of FIG. 1. The functionality 205 of the wireless access point begins at a block 211 wherein the access point initializes by making initial assessment of the cell. The initial assessment includes identifying the number of wireless end point devices that are attempting to access a backbone network that the wireless access point is connected to. In addition, the wireless access point queries each of the plurality of wireless end point devices regarding capabilities, demands of quality of service, anticipated bandwidth usage and idle states. As a part of initial assessment the wireless access point also searches for any noises and interferences that may occur within the cell. The capabilities of the plurality of wireless end point devices may include single transmissions and receptions capabilities, concurrent interfering transmissions and receptions capabilities or both. In addition, the wireless access point also verifies if the wireless end point devices have multiple radio band transmissions and receptions capabilities.

At a next block 213, the wireless access point identifies incoming and outgoing wireless end point devices. These incoming and outgoing wireless end point devices create additional bandwidth constraints on the wireless access point. At a next block 215, the wireless access point makes a periodic assessment of the respective cell to identify other factors that are mentioned in the above paragraph, that influence the performance of the wireless access point. At a next block 217, the wireless access point dynamically adapts to the current channel conditions. This is done by considering the number of single transmissions capable devices and number of concurrent transmissions capable devices, and further considering the other factors that influence the performance of the wireless access point such as bandwidth requirements, quality of service, noise and interferences. Then, by adjusting the length of portion of a current frame that is assigned for single transmission capable devices and allotting another portion of the current frame for concurrent interfering transmissions capable devices.

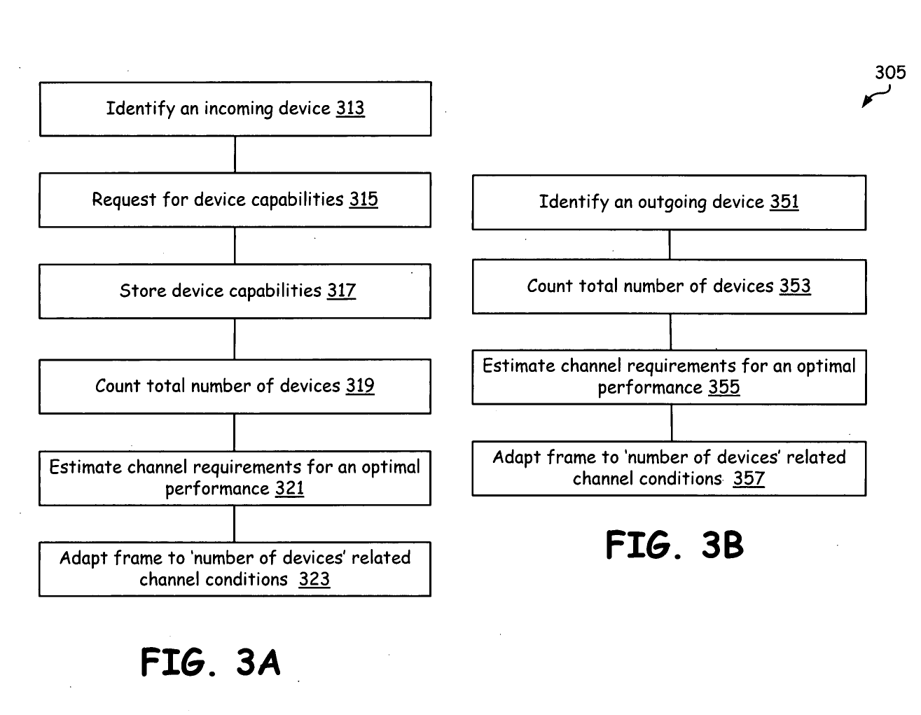

FIG. 3A is a flow diagram illustrating flow of functionality of the wireless access point of FIG. 1, wherein the wireless access point adapts the frame in response to the varying channel conditions created by an incoming wireless end point device. The functionality begins at a block 313, when the wireless access point identifies an incoming wireless end point device. At a next block 315, the wireless access point requests for the devices capabilities and collects other relevant information such as anticipated bandwidth usage, QOS (Quality of Service) demands, priority of service and idle states. At a next block 317, the wireless access point stores the device capabilities and the collected information. The device capabilities include single transmission capability alone, concurrent interfering transmission capabilities alone, or both, single to concurrent transmission capabilities and number of radio channels that the incoming wireless end point can use.

At a next block 319, the wireless access point counts the number of associated wireless end point devices, within the cell. In addition, the wireless access point makes periodic assessments (block 215 of FIG. 2) to gather information of anticipated bandwidth usage, QOS (Quality Of Service) demands, priority of service and idle states, from all of the associated wireless end point devices. The wireless access point also collects information regarding cell overlap interferences, near-far interferences and noises, during these periodic assessments. In this case, the periodic assessments may be based upon the time at which the wireless end point device comes in to the cell.

At a next block 321, the wireless access point estimates channel requirements for an optimal performance, considering all of the factors that varies channel conditions, created by the incoming wireless end point device. While considering the factors that vary channel conditions that are created by the incoming device in the block 321, or during periodic assessment, the wireless access point also simultaneously considers other factors as described with reference to the FIGS. 3B, 4A, 4B, 5A and 5B. Then, at a next block 323, the wireless access point adapts the frame between single and concurrent interfering transmissions, by taking into consideration the number of wireless end point devices related channel condition variations.

FIG. 3B is a flow diagram illustrating flow of functionality of the wireless access point of FIG. 1, wherein the wireless access point adapts the frame in response to the varying channel conditions created by an outgoing wireless end point device. The functionality begins at a block 351, when the wireless access point identifies an outgoing wireless end point device. At a next block 353, the wireless access point counts the number of wireless end point devices associated with it. In addition, the wireless access point makes periodic assessments (block 215 of FIG. 2) to gather information of anticipated bandwidth usage, QOS (Quality Of Service) demands, priority of service and idle states, from all of the associated wireless end point devices that may not include the outgoing wireless end point device. The wireless access point also collects information regarding cell overlap interferences, near-far interferences and noises, during these periodic assessments. In this case, the periodic assessments may be based upon the time at which the wireless end point device leaves the cell.

At a next block 355, the wireless access point estimates channel requirements for an optimal performance, considering all of the factors that varies channel conditions, created by the outgoing wireless end point device. Then, at a next block 357, the wireless access point adapts the frame between single and concurrent interfering transmissions, by taking into consideration the number of wireless end point devices related channel condition variations.

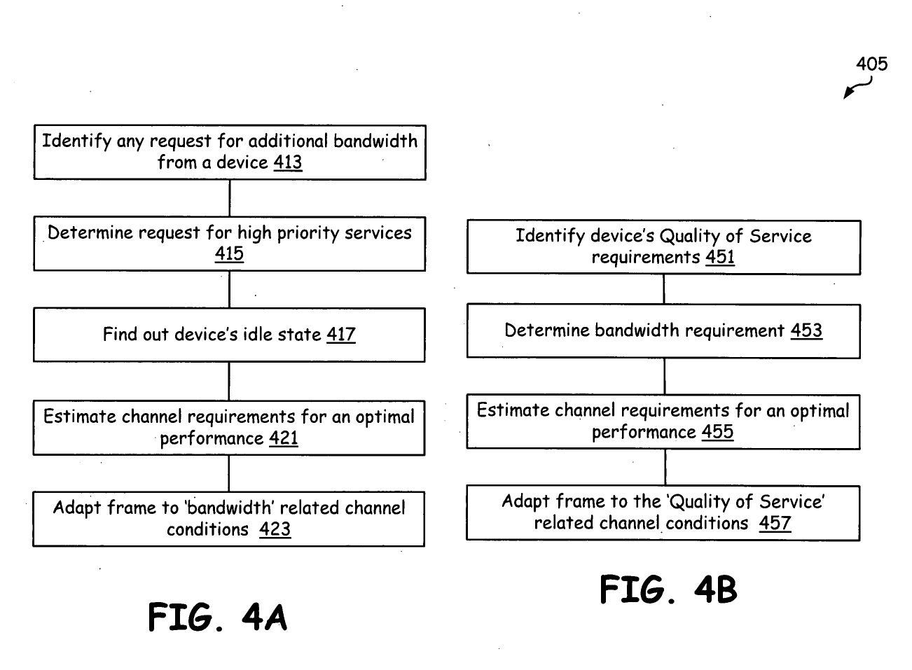

FIG. 4A is a flow diagram illustrating flow of functionality of the wireless access point of FIG. 1, wherein the wireless access point adapts the frame in response to the varying channel conditions created by varying bandwidth requirements, high priority services and idle states of a wireless end point device. The functionality begins at a block 413, when the access point identifies any request for an additional bandwidth from the wireless end point device. Then, at a next block 415, the wireless access point determines request for any high priority services. The high priority services may include request for VoIP (Voice over Internet Protocol) communications, file transfers, picture transfers etc: At a next block 417, the wireless access point learns about the idle states of the wireless end point device.

At a next block 421, the wireless access point estimates channel requirements for an optimal performance, considering all of the factors that varies channel conditions that includes additional bandwidth requests and high priority service requests from the wireless end point device, created by the outgoing wireless end point device. Then, at a next block 423, the wireless access point adapts the frame between single and concurrent interfering transmissions, by taking into consideration the additional bandwidth and high priority service related channel condition variations.

FIG. 4B is a flow diagram illustrating flow of functionality of the wireless access point of FIG. 1, wherein the wireless access point adapts the frame in response to the varying channel conditions created by varying quality of service of a wireless end point device. The functionality begins at a block 451, when the access point learns about the quality of service requirements of the wireless end point device. At a next block 453, the wireless access point determines the bandwidth requirements to provide the necessary quality of service.

At a next block 455, the wireless access point estimates channel requirements for an optimal performance, considering the quality of service requests from the wireless end point device. Then, at a next block 457, the wireless access point adapts the frame between single and concurrent interfering transmissions, by taking into consideration the quality of service related channel condition variations.

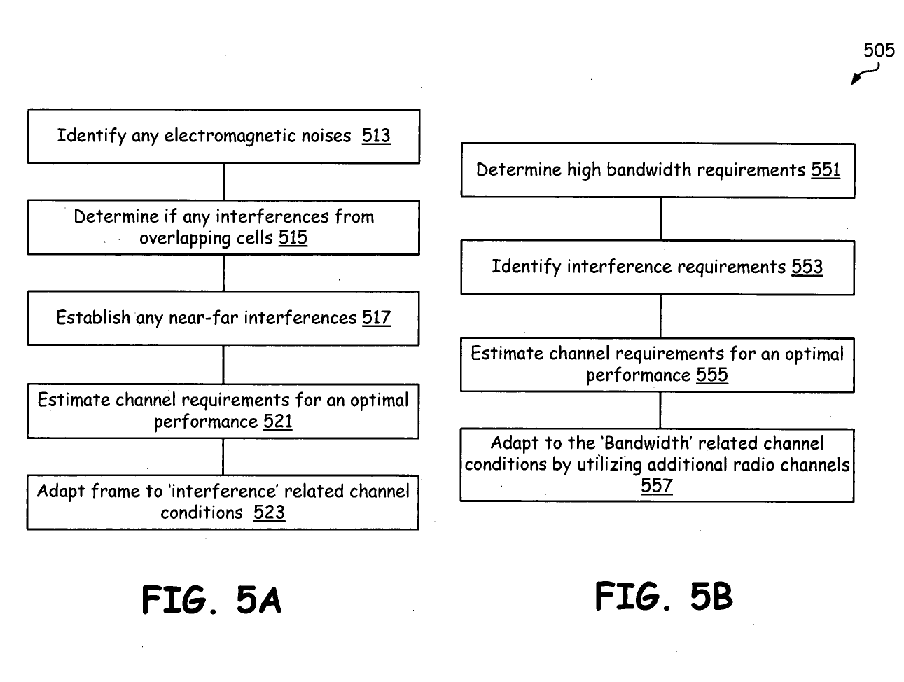

FIG. 5A is a flow diagram illustrating flow of functionality of the wireless access point of FIG. 1, wherein the wireless access point adapts the frame in response to the varying channel conditions created by electromagnetic noises and interferences within the wireless network infrastructure. The functionality begins at a block 513, with the access point identifying electromagnetic noises. The electromagnetic noises generate errors in communication with wireless end point devices, thus necessitating additional error correction measures. In turn the wireless access point utilizes additional bandwidth to over come the limitation that the electromagnetic noise creates.

At a next block 515, the wireless access point determines if any error is caused by the overlapping cells. At a next block 517, the wireless access point determines any interference caused by near-far effect. These interferences also have similar limiting effects as electromagnetic noises, on the wireless access point. The wireless access point, in this case, for example, may allot an additional period for concurrent interfering transmissions.

At a next block 521, the wireless access point estimates channel requirements for an optimal performance, considering the electromagnetic noises and the interferences. Then, at a next block 523, the wireless access point adapts the frame between single and concurrent interfering transmissions, by taking into consideration the electromagnetic noises and the interferences related channel condition variations.

FIG. 5B is a flow diagram illustrating flow of functionality of the wireless access point of FIG. 1, wherein the wireless access point utilizes additional radio channels in response to the varying channel conditions created by high bandwidth requirements of a wireless end point device and interferences within the wireless network infrastructure. The functionality begins at a block 551, with the wireless access point determining the high bandwidth requirements. The higher bandwidth requirements may have been caused, for example, by high number of wireless end point devices entering the cell or a high number of wireless end point devices requesting for additional bandwidth. This situation may occur at public places such as airports, while passengers are waiting for their flight. These additional bandwidth requirements degrade the performance of the wireless access point and cause inconveniences to the users. At a next block 553, the wireless access point assesses interferences caused by the wireless devices at overlapping areas between the cells.

At a next block 555, the wireless access point estimates channel requirements for an optimal performance, considering the high bandwidth requirements. Then, at a next block 557, the wireless access point utilizes additional radio channels in response to the varying channel conditions created by high bandwidth requirements of a wireless end point device and interferences within the wireless network infrastructure. The wireless access point utilizes additional radio channels when frame adaptation alone is not enough to overcome the performance degradation.

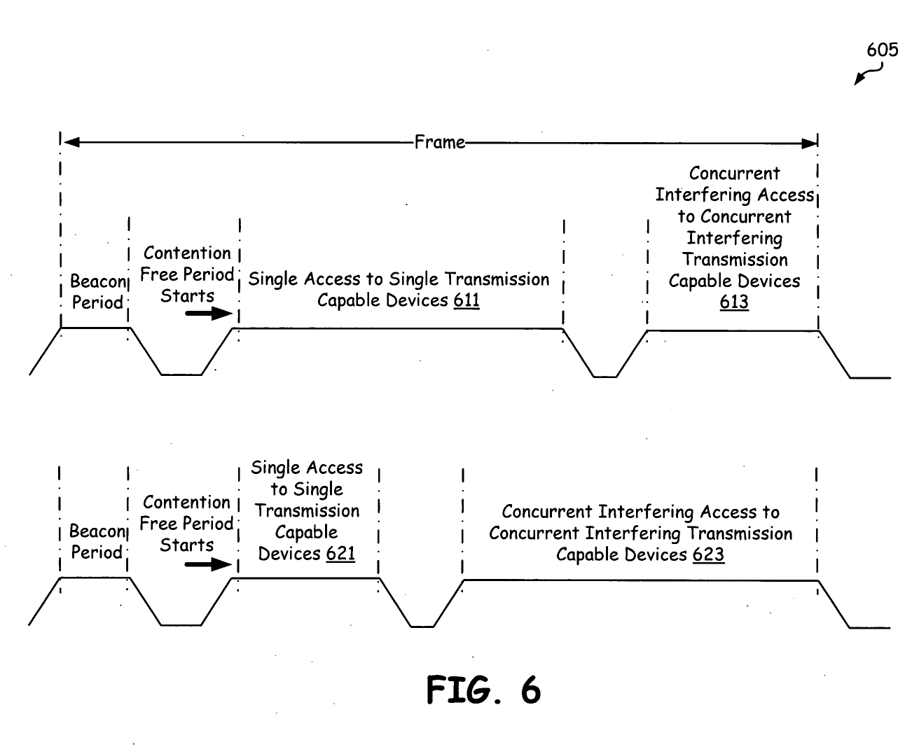

FIG. 6 is a timing diagram illustrating adaptation of frame 605 between single and concurrent interfering transmissions and receptions based on channel conditions, wherein channel conditions demand low or high bandwidth. As illustrated, a frame contains a beacon period and a contention free transmission period. The contention free transmission in turn period contains a period that allows single access to single transmissions capable devices, and another period that allows either or both of single transmissions and concurrent interfering transmission to concurrent transmissions capable devices.

The beacon period precedes contention free period. The beacon signals that determine the accesses to wireless access point in various modes during contention free period are transmitted to the single transmissions capable devices and concurrent interfering transmissions capable devices during the beacon period. The access modes include both single transmissions mode and concurrent interfering transmissions mode, and the decision to provide access in any mode and the duration of access depends on the wireless end point device capability and the wireless access point performance considerations. The beacon signals control the aspects of end point devices that include mode of transmission, contention free period accesses, and contention period arbitrations. All associated wireless end point devices respond to the beacon signals and plan their communication accordingly.

Following the beacon period, the contention free period begins by providing a portion for single transmission capable devices, that is, single transmission portion 611, and another portion for concurrent interfering transmission capable devices, that is, concurrent interfering transmission portion 613. During the single transmission portion 611 of the contention free period, the wireless access point senses channel being idle for a short duration and begins to transmit data to the single transmission capable wireless devices. The data transmission to the single transmission capable wireless devices is based upon polling and acknowledgement after transfer of data. Similar considerations apply for transmission of data from the single transmission capable wireless end point devices to the wireless access point.

Similarly, during the concurrent interfering transmission portion 613, the concurrent interfering transmission capable end point devices sense channel being idle for a short duration and transmit data to the wireless access point, simultaneously. The data transmission from the concurrent interfering transmission capable end point wireless devices is based upon acknowledgement after transfer of data. Similar considerations apply for transmission of data from the wireless access point to the concurrent interfering transmission capable wireless end point devices.

The wireless access point's adaptation of the frame between single and concurrent interfering transmissions is illustrated in two frames, with single transmission portions 611 and 621 and concurrent transmission portions 613 and 623. The wireless access point determines the durations of these portions 611, 613, 621 and 623 based upon the number of associated wireless end point devices within the cell, their capabilities, anticipated bandwidth usage, QOS (Quality of Service) demands, priority of service and idle states. The wireless access point also determines the durations based upon cell overlap interferences, near-far interferences and noises.

FIG. 7 is a schematic block diagram of an alternate embodiment 705 of the network infrastructure of FIG. 1 illustrating a wireless access point and variety of wireless end point devices, in accordance with various and other aspects of the present invention. Specifically, the wireless access point 707 provides routing to a variety of wireless end point devices such as a first end point device 769, second end point device 779, and third end point device 789, that are equipped with one or more of single transceiver circuitry, concurrent interfering transceiver circuitry, or single to concurrent interfering transceiver circuitry.

The first end point device 769 is equipped with single transceiver circuitry 771 (that is, a single transmission capable device) that is not capable of concurrent interfering transmissions. Therefore, the wireless access point 707 allocates a portion of contention free period to wireless end point devices such as 769 that are only equipped with single transmission transceiver circuitries. During this period, neither the wireless access point 707 nor wireless end point devices equipped with concurrent interfering transmission circuitry perform concurrent interfering transmissions or receptions. Similarly, during contention period, the wireless access point 707 provides routing to all of the single transmission capable devices depending on contention from the wireless end point devices and arbitration, during separate potions of the period.

The second wireless device 779 is equipped with single transceiver circuitry 781, concurrent interfering transceiver circuitry 783 (that is, a concurrent interfering transmission capable device). These transceivers are capable of performing both single transmissions and receptions, and concurrent interfering transmissions and receptions. The wireless access point 707 allocates a second portion of contention free period to wireless end point devices that are equipped with both single transceiver circuitries and concurrent interfering transceiver circuitries, so that depending upon load conditions single or concurrent interfering transmissions and receptions may be performed. In addition, during a contention period, the wireless access point 707 provides routing to the plurality of concurrent interfering transmission capable devices depending on contention from the wireless devices and arbitration, during separate potions of the period.

The third wireless device 789 is equipped single to concurrent interfering transceiver circuitry 791. This type of device may access the wireless access point 707 individually, but are capable of simultaneously communicating with a plurality of devices, including a plurality of wireless access points.

The wireless access point 707 achieves concurrent interfering transmissions and receptions by utilizing the built in radio frequency components and software components, which are part of a wireless transceiver circuitry 717. The software components include digital signal processing codes that assist in detecting and processing the data received via single or concurrent interfering transmission and reception. A primary controller 713 determines the channel conditions and based upon performance considerations allocate single and concurrent interfering transmissions portions of the period. That is, the primary controller 713 determines the durations of these portions based upon the number of associated wireless end point devices within the cell, their capabilities, anticipated bandwidth usage, QOS (Quality of Service) demands, priority of service and idle states. The primary controller 713 also determines the durations based upon cell overlap interferences, near-far interferences and noises. The primary controller 713 is a part of a processing circuitry 711, which may include a bridging circuitry 715.

Beacon signals generated by the primary controller 713 control the aspects of transmissions and receptions such as mode of transmission, contention free period accesses, and contention period arbitrations. All associated wireless devices listen to beacon signals generated by the wireless access point 707 and plan their communication accordingly. The bridge circuitry 715 provides the wireless access point 707 ability to bridge with other wireless access points as well as bridge with Internet (or any other backbone network) 751 via an upstream transceiver 709. The wireless access point 707 and the concurrent interfering transmission capable wireless devices such as 779 and 789 may have a plurality of antennas such as 733 and 731 and a plurality of tuners, thus being capable of communicating in more than one radio channel. In addition, local controllers 775, 797 and 795 manage functionality of the wireless devices 769, 779 and 789, respectively.

FIG. 8 is a schematic block diagram 805 of a wireless access point built in accordance with the embodiment of FIG. 7. The circuitry 895 may represent any of the wireless access points that route data packets. The wireless access point circuitry 895 generally includes central processing circuitry 809, local storage 811, user interfaces 813, upstream transceiver circuitry 821, bridging circuitry 841, wireless downstream transceiver circuitry 847, and primary downstream controller circuitry 881. These components communicatively coupled to one another via one or more of a system bus, dedicated communication pathways, or other direct or indirect communication pathways. The central processing circuitry 809 may be, in various embodiments, a microprocessor, a digital signal processor, a state machine, an application specific integrated circuit, a field programming gate array, or other processing circuitry. In addition, in various embodiments, the primary downstream controller circuitry 881 may be a controller card or part of a wireless access point circuitry card containing a microcontroller or microprocessor.

Local storage 811 may be random access memory, read-only memory, flash memory, a disk drive, an optical drive, or another type of memory that is operable to store computer instructions and data. The local storage 811 contains software components (not shown) that process received data in cases of both single transmission capable devices such as 769 of FIG. 7 and concurrent interfering transmission capable devices such as 779 of FIG. 7. These software components utilize digital signal processing (information processing) techniques to provide concurrent interfering access to a plurality of concurrent interfering transmission capable end point devices. The software components may include single transmission detection algorithm, single transmission algorithms, which assist in processing the data received from the single transmission capable devices and concurrent interfering transmission detection algorithms and concurrent interfering transmission algorithms which assist in processing the data received from the concurrent interfering transmission capable devices.

The decisions regarding single and concurrent interfering transmissions portions during both contention period and contention free period are transmitted to the single transmission capable devices and concurrent interfering transmission capable devices during a beacon period, by the primary downstream controller circuitry 881. The primary downstream controller circuitry 881 determines the durations of these portions based upon the number of associated wireless end point devices within the cell, their capabilities, anticipated bandwidth usage, QOS (Quality of Service) demands, priority of service, idle states, cell overlap interferences, near-far interferences, and noises. The beacon signals control the aspects of end point wireless devices that include mode of transmission, contention free period accesses, and contention period arbitrations. All associated wireless end point devices listen to beacon signals and plan their communication accordingly. Stored end-point device capability information 889 assist primary downstream controller circuitry 881 in making decisions regarding adaptations to varying channel conditions. In addition, the primary downstream controller circuitry 881 contains local transmitter control interfaces 883 and local receiver control interfaces 885 that allow the primary downstream controller circuitry 881 to interface with rest of the access point circuitry, specifically, the wireless downstream transceiver circuitry 847.

The wireless downstream transceiver circuitry 847 is equipped with an adaptive transmitter 849 and adaptive receiver 857 to handle the physical layer of protocol. The wireless downstream transceiver circuitry 847 is capable of performing both single transmission and receptions, and concurrent interfering transmission and receptions. The wireless downstream transceiver circuitry 847 is communicatively coupled to a plurality of antennas 831 that help communicate in multiple radio channels and a wider bandwidth. In one embodiment, the software information processing components mentioned above with regards to the local storage 811 may exist in storage of wireless downstream transceiver circuitry 847, to facilitate faster processing.

A bridge circuitry 841 allows bridging of the wireless access point 895 with other wireless access points as well as bridge with a backbone network via an upstream transceiver 821. The upstream transceiver circuitry 821 contains wired and wireless packet switched interfaces that provides the wireless access point ability to communicatively couple with a backbone network such as Internet, and is connected to a plurality of antennas 835 as well as a wire 833 that communicatively couples to the backbone network. In other embodiments, the access point circuitry 895 of the present invention may include fewer or more components than are illustrated as well as lesser or further functionality. In other words, the illustrated wireless device is meant to merely offer one example of possible functionality and construction in accordance with the present invention.

FIG. 9 is a schematic block diagram 905 of a wireless end point device built in accordance with the embodiment of FIG. 7. The circuitry 907 may represent any of the wireless end point devices from which packets originate or within which packets terminate and may represent any of the concurrent interfering transmission capable wireless end point devices of FIGS. 1 and 7. The wireless end point device 907 generally includes central processing circuitry 911, local storage 913, user interfaces 909, wireless transceiver circuitry 933, and communication interface 925. These components communicatively coupled to one another via one or more of a system bus, dedicated communication pathways, or other direct or indirect communication pathways.

The central processing circuitry 911 may be, in various embodiments, a microprocessor, a digital signal processor, a state machine, an application specific integrated circuit, a field programming gate array, or other processing circuitry. In addition, in various embodiments, the wireless transceiver circuitry 933 may consist of a local controller circuitry 961 containing a microcontroller or microprocessor. Local storage 913 may be random access memory, read-only memory, flash memory, a disk drive, an optical drive, or another type of memory that is operable to store computer instructions and data. The local storage 913 contains device operating system and application software 917 and optionally supplemental radio controller software 915. The communication interface 925 allows the wireless end point device 907 to interface with the wireless transceiver circuitry 933.

The wireless transceiver circuitry 933 contains the local controller circuitry 961, which in addition contains a single and concurrent interfering transceiver command processing 963. The local controller circuitry 961 manages control functionality of wireless transceiver circuitry 933. The control functionality of the wireless transceiver circuitry 933 include generating radio capability information and transmitting it to a wireless access point during a becon period as well as receiving the control signals from an associated access point, interpreting it and plan communication accordingly. The wireless transceiver circuitry 933 is also equipped with an adaptive transmitter 951 and adaptive receiver 953. The wireless transceiver circuitry. 433 is capable of performing both single transmission and receptions, and concurrent interfering transmission and receptions.

In other embodiments, the wireless end point device circuitry 907 of the present invention may include fewer or more components than are illustrated as well as lesser or further functionality. In other words, the illustrated wireless device is meant to merely offer one example of possible functionality and construction in accordance with the present invention.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A wireless network infrastructure supporting a plurality of end point devices that are either stationary or floating, the wireless network infrastructure comprising:
an access point;
a first plurality of end point devices, communicatively coupled to the access point, having first transceiver circuitry that supports single transmissions and receptions;
a second plurality of end point devices, communicatively coupled to the access point, having second transceiver circuitry that supports concurrent interfering transmissions and receptions;
a third plurality of end point devices, communicatively coupled to the access point, having either the first transceiver circuitry or the second transceiver circuitry and that are either entering into the cell or leaving the wireless network infrastructure;
the third plurality of end point devices create dynamically varying channel conditions in the wireless network infrastructure; and
the access point responds to the dynamically varying channel conditions by adapting a frame between the single transmissions and receptions, and the concurrent interfering transmissions and receptions.

2. The wireless network infrastructure of claim 1, wherein the access point defines at least one first portion of a frame wherein transmissions and receptions are limited to single transmissions and receptions.

3. The wireless network infrastructure of claim 1, wherein the access point defines at least one second portion of the frame wherein concurrent interfering transmissions and receptions are permitted.

4. The wireless network infrastructure of claim 1, wherein the adaptation of the frame defines an optimal performance considerations of the access point.

5. The wireless network infrastructure of claim 4, wherein the optimal performance considerations comprises bandwidth usage based upon number of end point wireless devices associated with the access point at any given time.

6. The wireless network infrastructure of claim 4, wherein the optimal performance considerations comprises bandwidth consumed by each of the plurality of end point devices.

7. The wireless network infrastructure of claim 4, wherein the optimal performance considerations. comprises quality of service provided to each of the plurality of end point devices.

8. A wireless network infrastructure comprising:
an access point;
a plurality of end point devices, communicatively coupled to the access point, each of the plurality of wireless devices having transceiver circuitry that supports either single transmission and receptions or concurrent interfering transmissions and receptions;
the plurality of end point devices create dynamically varying bandwidth requirements from the access point; and
the access point responds to the dynamically varying bandwidth requirements by adapting a frame between the single transmissions and receptions, and the concurrent interfering transmissions and receptions.

9. The wireless network infrastructure of claim 8, wherein the access point in addition responds to the dynamically varying bandwidth requirements by utilizing a plurality of transceiver circuitry.

10. The wireless network infrastructure of claim 9, wherein each of the plurality transceiver circuitry utilizes one of a plurality of radio bands.

11. The wireless network infrastructure of claim 8, wherein the access point defines at least one first portion of a frame wherein transmissions and receptions are limited to single transmissions and receptions.

12. The wireless network infrastructure of claim 8, wherein the access point defines at least one second portion of the frame wherein concurrent interfering transmissions and receptions are permitted.

13. The wireless network infrastructure of claim 8, wherein the access point adapts to the bandwidth requirements by varying the time duration between the single transmissions and receptions, and the concurrent interfering transmissions and receptions, within the frame.

14. The wireless network infrastructure of claim 13, wherein the adaptation of the frame defines an optimal performance considerations of the access point.

15. The wireless network infrastructure of claim 14, wherein the optimal performance considerations comprises bandwidth consumed by each of the plurality of end point devices.

16. The wireless network infrastructure of claim 14, wherein the optimal performance considerations comprises quality of service provided to each of the plurality of end point devices.

17. The wireless network infrastructure of claim 14, wherein the optimal performance considerations comprises considerations of interferences.

18. The wireless network infrastructure of claim 14, wherein the optimal performance considerations comprises considerations of noises.

19. A method performed by an access point that communicates a plurality of packets with a plurality of end point devices, in a wireless network infrastructure, the method comprising:
initializing;
identifying an end point device that is incoming;
receiving the device capability and bandwidth requirement information from the end point device;
counting total number of devices associated with the access point;
estimating channel requirements for an optimal performance; and
adapting a frame between single transmissions and receptions, and concurrent interfering transmissions and receptions based upon the requirements for an optimal performance.

20. The method of claim 19 further comprising:
identifying request for additional bandwidth from the end point device;
determining request for high priority services from the end point device;
finding out the end point device idle states;
estimating channel requirement for an optimal performance; and
adapting a frame between single transmissions and receptions, and concurrent interfering transmissions and receptions based upon the requirements for an optimal performance.
